(19) United States
(12) Patent Application Publication
(10) Pub. No.: US 2011/0317440 A1
(43) Pub. Date: Dec. 29, 2011

(54) Foot board with luminous structure for an automobile or a motorcycle

(76) Inventor: Rasner Chen, Tainan City (TW)

(21) Appl. No.: 12/803,465

(22) Filed: Jun. 29, 2010

(51) Int. Cl. B60Q 1/26

(52) U.S. Cl. 362/473; 362/488

(57) ABSTRACT

A foot board with luminous structure for an automobile or a motorcycle includes a foot board, a translucent plate, a luminous module and a connecting member combined together. The foot board is formed with a fit opening in the center, the luminous module is positioned at one side of the translucent plate by the connecting member, and the translucent plate with a certain thickness is set in the fit opening of the foot board. Thus, when the electric source of the luminous module is started, the light of the luminous module will be irradiated on the translucent plate and simultaneously, the thick translucent plate will magnify the light and give out flickering light. Different from conventional foot boards, the foot board with luminous structure of this invention is novel in design and interesting in use.

### BACKGROUND OF THE INVENTION

1. Field of the Invention

This invention relates to a foot board with luminous structure for an automobile or a motorcycle, particularly to one having a foot board fitted with a translucent plate and a luminous module. Thus, light of the luminous module can pass through the thick translucent plate and produce colorful light for attaining a novel amusement effect.

2. Description of the Prior Art

At present, most conventional foot boards of automobiles or motorcycles are only employed for foot to tread thereon, impossible to give out light for increasing pleasure in use and meeting a user's requirement.

### SUMMARY OF THE INVENTION

The objective of this invention is to offer a foot board with luminous structure for an automobile or a motorcycle, functioning to produce flickering light, novel and unique in design, and able to increase light and enhance safety when riding a motorcycle.

The foot board with luminous structure for an automobile or a motorcycle in the present invention includes a foot board formed with a fit opening, a translucent plate fitted in the fit opening of the foot board and provided with a linking member and reflecting surfaces as well as translucent surfaces, and a luminous module coupled with the connecting member and composed of a circuit board, a light source set and a switch. The connecting member is to be combined with both the translucent plate and the luminous module and disposed with an engage member.

### BRIEF DESCRIPTION OF DRAWINGS

This invention will be better understood by referring to the accompanying drawings, wherein:

FIG. 1 is an exploded perspective view of a foot board with luminous structure for an automobile or a motorcycle in the present invention;

FIG. 2 is a perspective view of the foot board with luminous structure for an automobile or a motorcycle in the present invention;

FIG. 3a is an upper view of the foot board with luminous structure.

FIG. 3b is a cross-sectional view of the line I-I in FIG. 3a.

FIG. 3c is a magnified view of the part marked (A) in FIG. 3b;

FIG. 4 is a schematic view of a translucent plate and a connecting member that are being combined together in the present invention;

FIG. 5 is a schematic view of the foot board with luminous structure used in a motorcycle in the present invention;

FIG. 6 is a schematic view of the foot board with luminous structure used in an automobile in the present invention;

FIG. 7 is a schematic view of the foot board with luminous structure, which has the translucent plate and the luminous module broadened in the dimensions, and the foot board is used in a motorcycle in the present invention; and

FIG. 8 is a schematic view of the foot board with luminous structure, which has the translucent plate and the luminous module widened in the dimensions, and the foot board is used in an automobile in the present invention.

### DETAILED DESCRIPTION OF THE PREFERRED EMBODIMENT

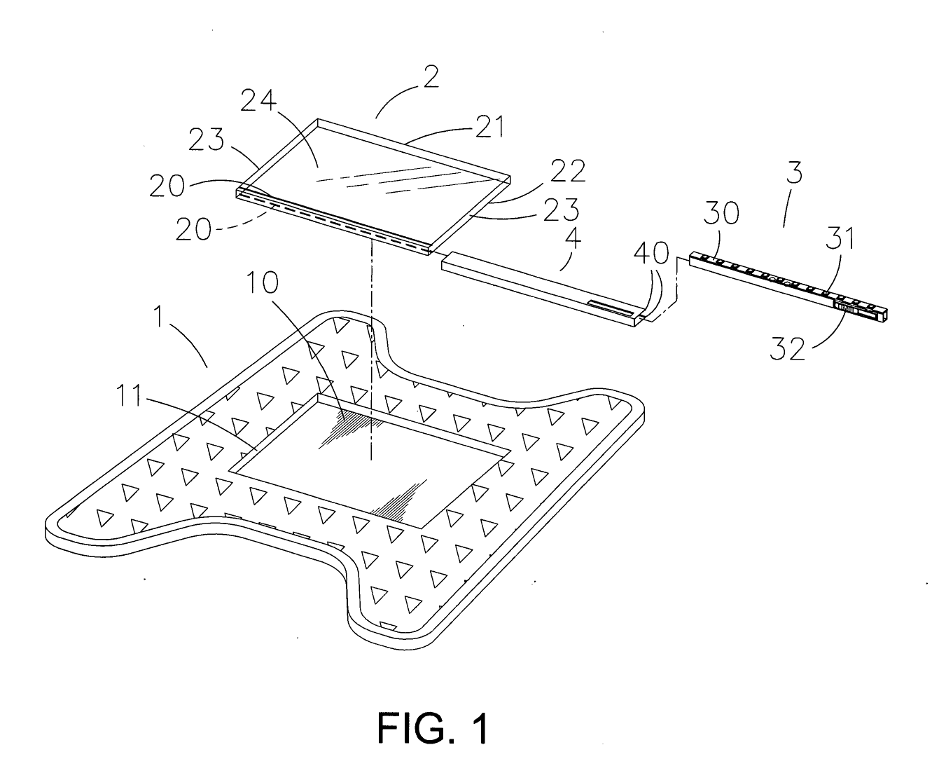

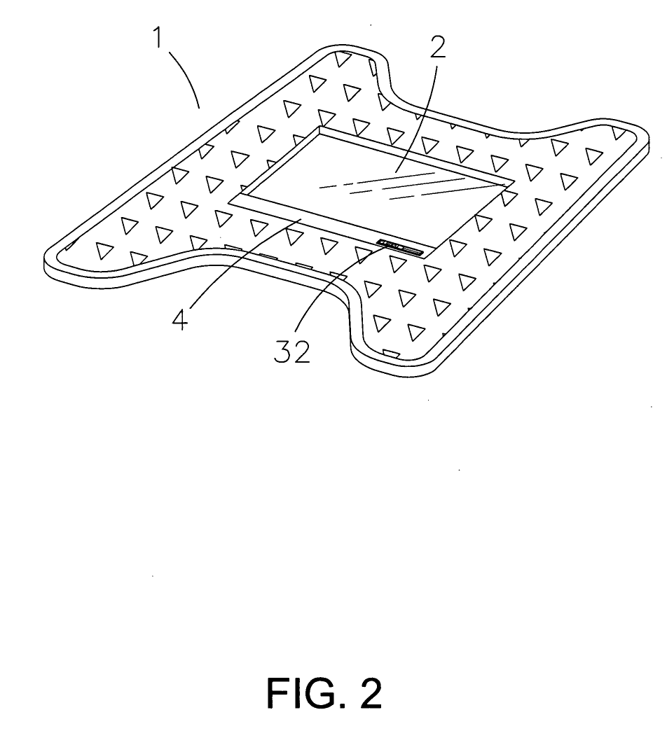

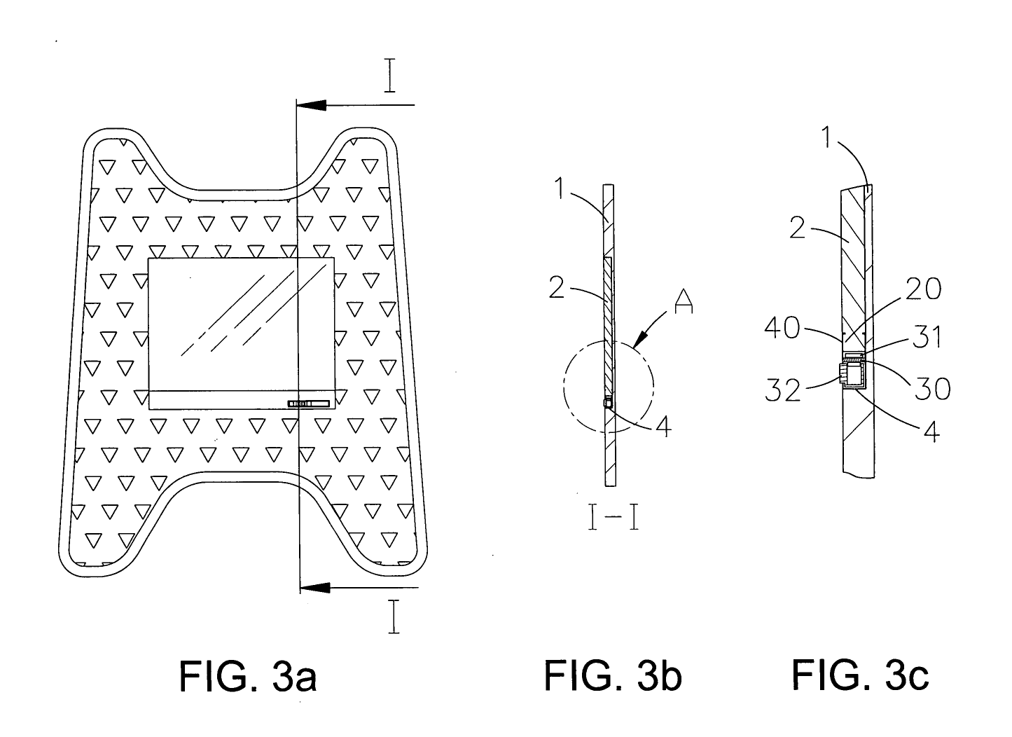

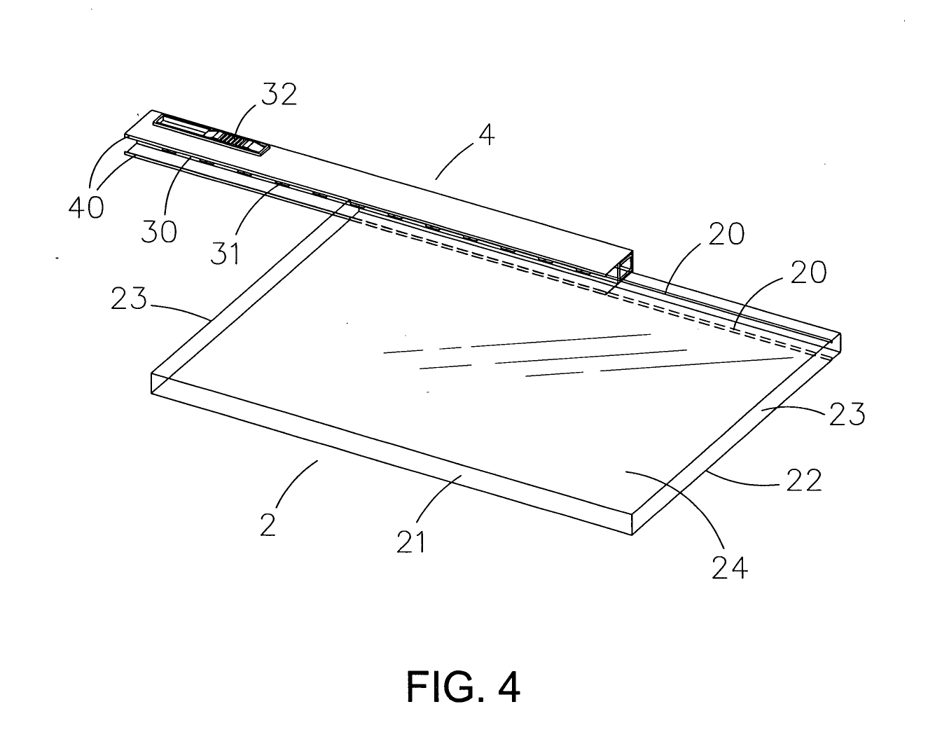

A preferred embodiment of a foot board with luminous structure for an automobile or a motorcycle in the present invention, as shown in FIGS. 1-4, includes a foot board 1, a translucent plate 2, a luminous module 3 and a connecting member 4 as main components combined together.

The foot board 1 is formed with a fit opening 10 with four translucent edges 11.

The translucent plate 2 is set in the fit opening 10 of the foot board 1 and formed with a certain thickness, able to magnify light source and produce brilliant light. The translucent plate 2 has its upper and lower front end respectively formed with a linking member 20, and its rear end and its underside respectively processed to form a reflecting surface 21, 22 and further, its two sides and its front side are respectively formed with a translucent surface 23, 24.

The luminous module 3 to be assembled with the connecting member 4 is disposed with a circuit board 30, a light source set 31 (such as light-emitting diodes and light bulbs) and a switch 32. The light source set 31 can be composed of plural sets of different-color lamps while the circuit board 30 is designed to enable the light source set 31 to produce light changing and flickering frequencies, and the switch 32 connects the circuit board 30 and the light source set 31 in series and controls them.

The connecting member 4 is to be combined with both the translucent plate 2 and the luminous module 3, having its upper and lower end respectively provided with an engage member 40.

In assembling, firstly, the luminous module 3 and the connecting member 4 are fitted with each other and then, the engage member 40 of the connecting member 4 is engaged with the linking member 20 of the translucent plate 2, letting the light source set 31 of the luminous module 3 exactly face the end of the translucent plate 2. Next, the translucent plate 2 is firmly set in the fit opening 10 of the foot board 1 to have the translucent plate 2 and the foot board 1 kept in a flush and horizontal condition.

In using at night, only remove the old foot board from an automobile or a motorcycle and assemble the new foot board 1 of this invention instead and then, turn on the switch 32 of the luminous module 3. At this time, the circuit board 30 on the luminous module 3 will control the light source set 31 to produce flickering light and change light colors. Simultaneously, the bright light emitted by the light source set 31 will shine on the translucent plate 2 to be reflected by the reflecting surfaces 21, 22 of the translucent plate 2, and then the reflected light will pass through the translucent surfaces 23, 24 to brighten both the front side and the translucent edges 11 of the foot board 1.

As can be understood from the above description, this invention has the following advantages.

1. The foot board with luminous structure for an automobile or a motorcycle of this invention is disposed with the translucent plate 2 and the luminous module 3 to enable the light emitted by the luminous module 3 to be reflected by the reflecting surfaces 21, 22 of the translucent plate 2 for giving out eye-catching bright light.

2. The old foot board of an automobile or a motorcycle can easily and conveniently be replaced with the new foot board with luminous structure of this invention.

3. The foot board 1 with luminous structure of this invention can give out eye-catching bright light for attracting people's attention, able to insure safety in motorcycle riding.

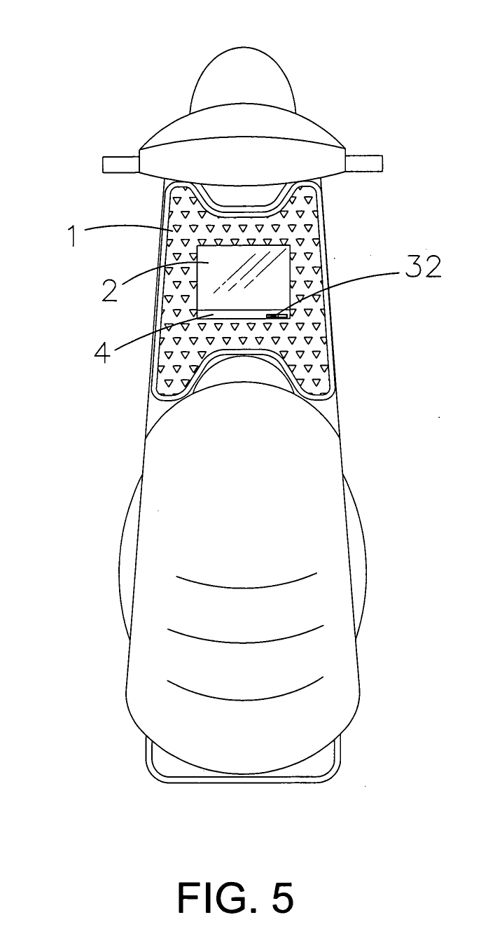

4 The foot board 1 with luminous structure of this invention can be directly placed on the original foot board of a motorcycle, as shown in FIG. 5, able to give out flickering light.

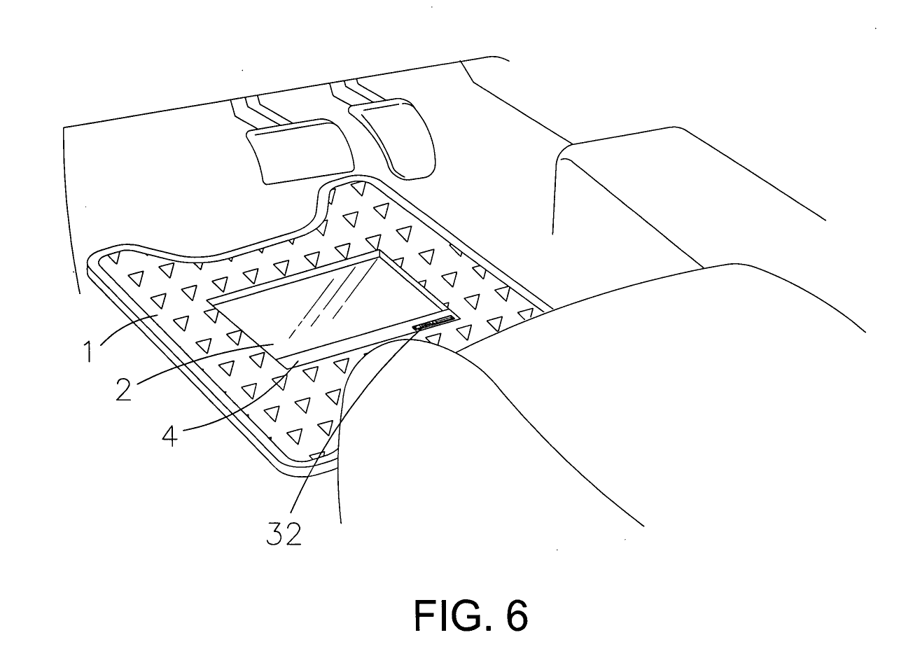

5. The foot board 1 with luminous structure of this invention can also be used in an automobile for changing various lights in the automobile, as shown in FIG. 6.

6. The linking member 20 of the translucent plate 2 of this invention have the inner side of their ends respectively formed with an arcuate surface so that the luminous module 3 and the translucent plate 2 can produce comparatively good irradiation surfaces.

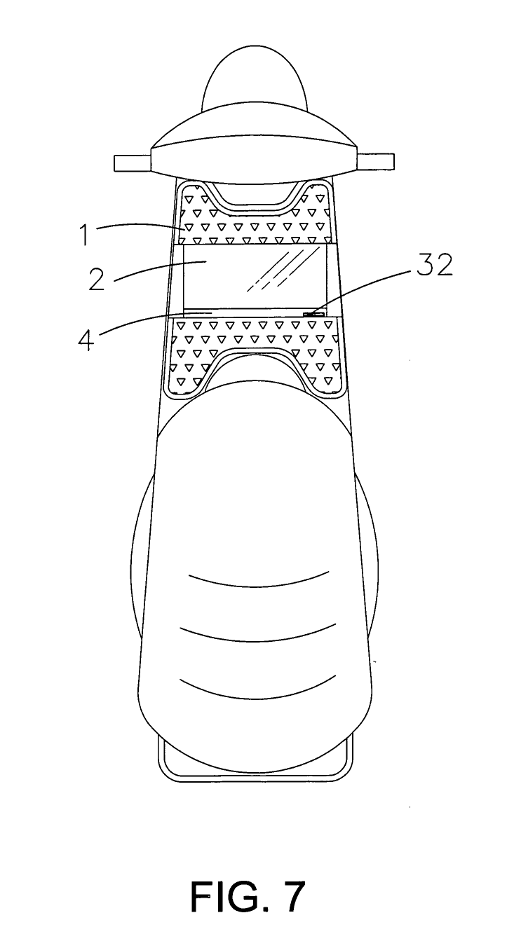

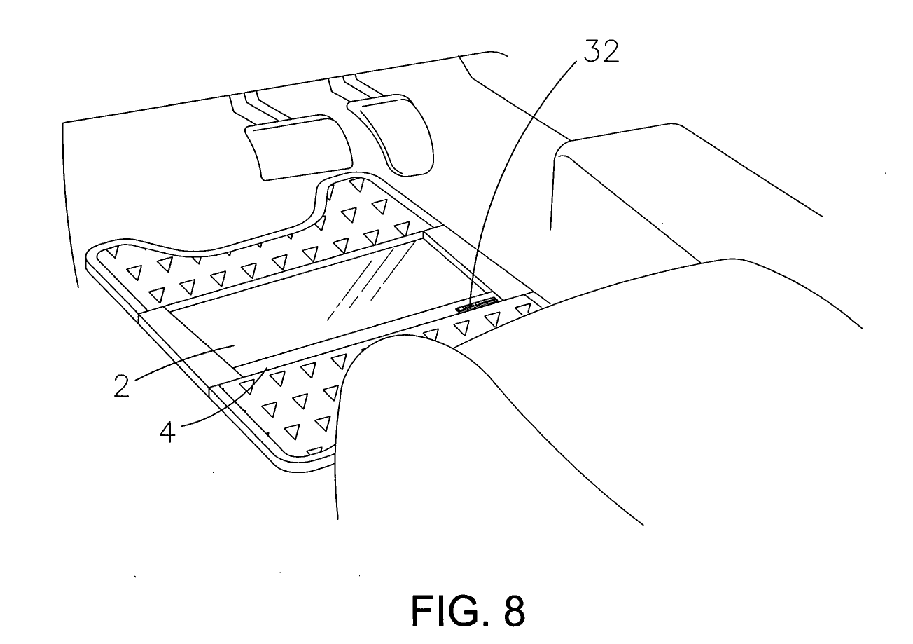

7. The translucent plate 2 and the luminous module 3 can be broadened in the dimensions for enlarging the irradiation range of the foot board 1, as shown in FIGS. 7 and 8.

While the preferred embodiment of the invention has been described above, it will be recognized and understood that various modifications may be made therein and the appended claims are intended to cover all such modifications that may fall within the spirit and scope of the invention.

What is claimed is:

1. A foot board with a luminous structure for an automobile or a motorcycle comprising:
a foot board formed with a fit opening;
a translucent plate fitted in said fit opening of said foot board, said translucent plate provided with a linking member, reflecting surfaces and translucent surfaces;
a luminous module assembled on a connecting member, said luminous module composed of a circuit board, a light source set and a switch;
said connecting member combined on both said translucent plate and said luminous module, said connecting member provided with an engage member; and
by assembling together all foresaid components, a foot board with luminous structure formed and able to give out flickering light.

2. The foot board with luminous structure for an automobile or a motorcycle as claimed in claim 1, wherein said light source set of said luminous module is composed of light-emitting diodes (LEDs) and light bulbs.

3. The foot board with luminous structure for an automobile or a motorcycle as claimed in claim 1, wherein said foot board, said translucent plate and said luminous module can be directly combined on a motorcycle for giving out flickering light.

4. The foot board with luminous structure for an automobile or a motorcycle as claimed in claim 1, wherein said translucent plate is made of a thick plate able to produce brilliant light when light is irradiated on said translucent plate.
